(19) United States
(12) Patent Application Publication
(10) Pub. No.: US 2012/0193301 A1
(43) Pub. Date: Aug. 2, 2012

(54) VACUUM-EVAPORATION-BASED VOC RECOVERY DEVICE AND METHOD THEREFOR

(75) Inventors: Tamotsu Fujioka, Yokohama-shi (JP); Shigeru Tanaka, Yokohama-shi (JP)

(73) Assignees: KEIO UNIVERSITY, Tokyo (JP); ANEST IWATA CORPORATION, Yokohama-shi (JP)

(21) Appl. No.: 13/359,598

(22) Filed: Jan. 27, 2012

(30) Foreign Application Priority Data
Jan. 31, 2011 (JP) 2011-018538

(51) Int. Cl. B01D 19/00

(52) U.S. Cl. 210/750; 210/177

(57) ABSTRACT

A Volatile Organic Compounds (VOC) removal solution regeneration and recovery apparatus removes VOC contained in a VOC removal solution. The apparatus includes a liquid pump, a vacuum vessel, a vacuum pump, a gas introducing mechanism that introduces an evaporation enhancing gas into the vacuum vessel, and a liquid discharge mechanism that discharges processed VOC removal solution from the vacuum vessel. The apparatus further includes a compressor that generates compressed air having thermal energy and pressure energy. The liquid pump is an air-driven pump that is driven by air pressure as a power source, and the pressure energy of the compressed air is used as the power source of the liquid pump.

### BACKGROUND OF THE INVENTION

1. Field of the Invention

The present invention relates to a VOC (Volatile Organic Compounds) removal solution regeneration and recovery apparatus for removing VOC contained in the VOC removal solution (referred to hereinbelow as “removal solution”) used for removing VOC and recovering the removal solution and to a regeneration and recovery method therefor.

2. Description of the Related Art

VOC are contained, for example, in waste gases generated during coating or printing, and when the waste gases including VOC are directly released into the atmosphere, they are known to cause secondary contamination. Accordingly, techniques for removing VOC from the waste gases have been investigated.

Japanese Patent Application Laid-open No. 2002-273157 discloses a technique for removing VOC from the waste gases. With the technique disclosed in Japanese Patent Application Laid-open No. 2002-273157, an absorption liquid recovery tank is provided for recovering the removal solution (absorption liquid) that has been brought into contact with VOC (waste gas) and has absorbed the VOC. The absorption liquid recovery tank is provided with a heater and configured to evaporate and remove the VOC from the removal solution by heating with the heater.

Japanese Patent Publication No. 2949732 discloses another technique for removing VOC from waste gases, this technique relating to a removal solution recover mechanism using a degassing membrane. The technique disclosed in Japanese Patent Publication No. 2949732 uses a module in which the liquid to be treated is introduced to one side of a gas-permeable membrane and the gas phase at the other side is depressurized, thereby removing the gas or volatile compounds contained in the liquid to a gas-phase chamber. In the configuration disclosed in Japanese Patent Publication No. 2949732, an air bleeder is provided for introducing air as a carrier gas into the depressurized gas-phase chamber. The air bleeder is means for enhancing degassing and preferably provided at a position such that the volatile substances that has between transmitted through the gas-permeable membrane can be effectively taken away by the gas introduced from the air bleeder. A nonporous or porous membrane such as a flat membrane, hollow thread membrane, or tubular membrane can be used as the gas-permeable membrane.

However, the problem associated with the technique disclosed in Japanese Patent Application Laid-open No. 2002-273157 is that since the heater is used to recover the removal solution (absorption liquid), power consumption is high and the respective amount of extra CO₂ is released. The problem associated with the technique disclosed in Japanese Patent Publication No. 2949732 is that since the gas-permeable membrane is required, the processing efficiency is degraded by the adverse effect produced on the volatile compounds during permeation.

### PATENT REFERENCES

Patent Reference 1: Japanese Patent Application Laid-open No. 2002-273157; and Patent Reference 2: Japanese Patent Publication No. 2949732

### SUMMARY OF THE INVENTION

Accordingly, it is an object of the present invention to provide a VOC removal solution regeneration and recovery apparatus in which no heater is used and therefore the release of CO₂ can be reduced by the amount corresponding to the power consumed when the heater is used and in which no gas-permeable membrane is required and therefore volatile compounds are not adversely affected when passing through the gas-permeable membrane, and also to provide a VOC removal solution regeneration and recovery method therefor.

To attain the abovementioned object, the present invention provides a VOC removal solution regeneration and recovery apparatus that regenerates and recovers a VOC removal solution by removing VOC included in the VOC removal solution, including: a liquid pump and a nozzle that spray the VOC removal solution; a vacuum vessel that has the nozzle disposed inside thereof; a vacuum pump that depressurizes an interior of the vacuum vessel and vacuum-evaporates the VOC included in the VOC removal solution; a gas introducing mechanism that introduces an evaporation enhancing gas into the vacuum vessel; and a liquid discharge mechanism that discharges the processed VOC removal solution from the vacuum vessel, and this apparatus further including a compressor that compresses air supplied from the outside and generates compressed air having thermal energy and pressure energy, wherein a heat exchanger is provided at a passage from the liquid pump to the nozzle, heat exchange between the VOC removal solution and the compressed air is performed by the heat exchanger, and the thermal energy is supplied to the VOC removal solution. The liquid pump is an air-driven pump that is driven by air pressure as a power source, wherein the pressure energy of the compressed air is used as the power source of the liquid pump.

As a result, the VOC removal solution pumped by the liquid pump is sprayed from the nozzles inside the vacuum vessel. The interior of the vacuum vessel is depressurized by the action of the vacuum pump, thereby causing vacuum evaporation of the VOC from the VOC removal solution. Since the VOC removal solution is atomized by spraying, the surface area thereof is greatly increased by comparison with that attained with simple storage. In combination therewith, the introduction of the evaporation enhancing gas by the gas introducing mechanism increases the efficiency of vacuum evaporation. Thus, the VOC removal solution can be efficiently regenerated and recovered. The “vacuum evaporation” as referred to herein means a method by which the pressure of a gas phase is reduced and volatile substances or the like are separated from the VOC removal solution.

The VOC removal solution can be also heated and vacuum evaporation can be performed even more efficiently by using the thermal energy of the compressed air for heating the VOC removal solution. This can be done by transferring the thermal energy of the high-temperature and high-pressure compressed air generated by the compressor to the VOC removal solution by using the heat exchanger.

Further, since the pressure energy of the compressed air that has been cooled after the heat exchange is used as a power source of the liquid pump for pumping the VOC removal solution into the vacuum vessel, the pressure energy of the compressed air generated by the compressor can be used effectively without loss.

Therefore, since no heater is used, the release of CO₂ can be reduced by the amount corresponding to the power consumed when the heater is used, and because no gas-permeable membrane is required, volatile compounds are not adversely affected when passing through the gas-permeable membrane. Furthermore, the VOC contained in the VOC removal solution can be removed therefrom with high efficiency and the removal solution can be recovered.

Further, a liquid storage tank that stores the VOC removal solution discharged from the liquid discharge mechanism may be provided and compressed air introducing means for introducing into the liquid storage tank the compressed air after the heat exchange by the heat exchanger may be also provided. Two liquid storage tanks may be provided and storage of the removal solution may be performed alternately. As a result, the pressure energy of the compressed air generated by the compressor can be used more effectively.

An air tank that stores the compressed air after the heat exchange in the heat exchanger may be provided. As a result, the air tank serves as a buffer for the compressed air and the pressure energy of the compressed air can be used with even lower loss.

Further, the compressed air from the compressor may be used instead of the atmospheric air for the evaporation enhancing gas. Abrupt cooling inside the vacuum tank can be inhibited by directly introducing the heated air into the vacuum tank.

Further, to solve the abovementioned problem, the present invention provides a VOC removal solution regeneration and recovery method for regenerating and recovering a VOC removal solution by removing VOC included in the VOC removal solution, including: depressurizing an interior of a vacuum vessel with a vacuum pump, while spraying into the interior of the vacuum vessel the VOC removal solution that has been heated by heat exchange with a compressed gas generated by a compressor, and vacuum evaporating VOC included in the VOC removal solution by introducing an evaporation enhancing gas into the vacuum vessel. The compressed air after the heat exchange is used as a power source of a liquid pump for spraying the VOC removal solution.

The VOC removal solution after the VOC have been vacuum evaporated may be stored in a liquid storage tank provided outside the vacuum vessel, and the VOC removal solution may be discharged from the liquid storage tank by the pressure of the compressed air after the heat exchange.

The present invention provides a VOC removal solution regeneration and recovery apparatus in which no heater is used and therefore the release of CO₂ can be reduced by the amount corresponding to the power consumed when the heater is used and in which no gas-permeable membrane is required and therefore volatile compounds are not adversely affected when passing through the gas-permeable membrane and also provides a VOC removal solution regeneration and recovery method therefor.

### BRIEF DESCRIPTION OF THE DRAWINGS

FIG. 1 is system diagram illustrating a VOC removal solution regeneration and recovery apparatus of an embodiment; and

FIG. 2A and FIG. 2B illustrate the results of the VOC regeneration and recovery test.

### DESCRIPTION OF THE PREFERRED EMBODIMENTS

The preferred embodiments of the present invention will be described below in detail with reference to the appended drawings. However, size, shape, materials, and arrangements of parts described in the embodiment are not particularly limiting and should not be construed as restricting the scope of the invention unless otherwise indicated specifically.

### Embodiment

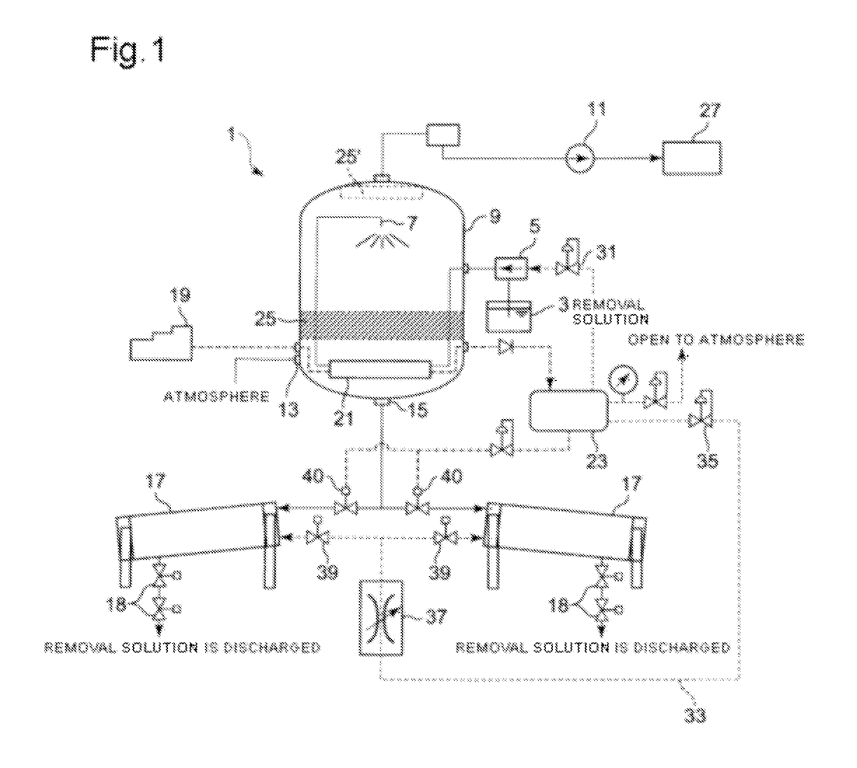

FIG. 1 is a system diagram illustrating a VOC removal solution regeneration and recovery apparatus of an embodiment. A VOC removal solution regeneration and recovery apparatus 1 (referred to hereinbelow as “regeneration and recovery apparatus 1”) removes VOC from a VOC removal solution (referred to hereinbelow as “removal solution to be treated”) including VOC and regenerating and recovering a VOC removal solution (referred to hereinbelow as “regenerated removal solution”).

The structure of the regeneration and recovery apparatus of the present embodiment will be explained below with reference to FIG. 1. The regeneration and recovery apparatus 1 shown in FIG. 1 is constituted by a storage tank 3, a liquid pump 5, a spraying nozzle 7, a vacuum vessel 9, a vacuum pump 11, a gas introducing mechanism 13, a liquid discharge mechanism 15, a liquid storage tank 17, a compressor 19, a heat exchanger 21, and an air tank 23.

The storage tank 3 stores a VOC removal solution (removal solution to be treated) supplied from the outside. It is also possible not to provide the storage tank 3 and take the removal solution to be treated directly from the VOC removal device (not shown in the figure), instead of the storage tank 3, or to provide the liquid pump 5 in the liquid supply pipe (not shown in the figure) for the removal solution to be treated. The liquid pump 5 pumps the removal solution that has been stored in the storage tank 3 to the nozzle 7. The nozzle 7 serves to spray the pumped removal solution inside the vacuum vessel 9. A cooling and condensing device 27, which is a VOC treatment mechanism, is provided at the discharge side of the vacuum pump 11. The compressor 19 generates high-temperature and high-pressure compressed air. The heat exchanger 21 serves to perform heat exchange between the compressed air generated by the compressor 19 and the removal solution that will be pumped to the nozzle 7 from the liquid pump 5 and increase the temperature of the removal solution to be treated. The air tank 23 serves to store the compressed air that has underwent by the heat exchanger 21 heat exchange with the removal solution to be treated.

The vacuum vessel 9 is a tubular vessel that is depressurized by the vacuum pump 11 connected thereto. The nozzle 7 is provided in the upper portion inside the vacuum vessel 9. The gas introducing mechanism 13 is provided in the lower portion and the liquid discharge mechanism 15 is provided in the lowermost portion of the vacuum vessel. A mist trap 25 is provided in the intermediate position in the height direction inside the vacuum vessel 9, namely, below the nozzle 7 and above the gas introducing mechanism, and a mist trap 25′ is provided in the upper portion of the vacuum vessel 9 above the nozzle 7. The heat exchanger 21 is provided below the mist trap 25. In the present embodiment, the heat exchanger 21 is provided inside the vacuum vessel 9, but it may be also provided outside the vacuum vessel.

In the present embodiment, the mist trap 25 is constituted by a polyurethane foam which is an open-cell foam and a support body located therebelow. The polyurethane foam is lightweight and inexpensive and can be easily procured. When the polyurethane foam is a cube with a length of one side of 1 m (that is, with a volume of 1 m³), it has a very large surface area (total surface area of cell walls) of 1490 m² per unit volume. Another advantage of such a configuration is that the porosity is 0.97 and practically no resistance is offered to the passing VOC removal solution. Accordingly, the total surface area of the removal solution that adheres to the cell walls also greatly increases, thereby making it possible to realize very efficient vacuum evaporation of VOC. The polyurethane foam weighs less and is less expensive (by a factor of 10 or less) than the conventional ceramic porous bodies for gas adsorption and is very easy to use. Foams other than the polyurethane foam can be also used, provided that they have a porous structure in which cell walls located between the adjacent pores communicate with each other and the removal solution to be treated can adhere to the cell walls. The mist trap 25′ also can use a polyurethane foam, similarly to the mist trap 25, but other foams with open cells and other members can be also used, provided that the object of mist trapping is attained.

The support body constituting the mist trap 25 is a mesh-like member attached so as to cross the interior of the vacuum vessel 9. Since the support body has a mesh-like structure, the removal solution to be treated can drop down from the open-cell foam, without remaining in a large amount on the support body. Therefore, the meshes of the support body should be small enough to support the open-cell foam from below and large enough to enable smooth downward flow of the VOC removal solution. The support body can also be in the form of a portable slatted floor piece or a sheet member having a large number of small holes formed therein, such as a punching metal, provided that the aforementioned object can be attained. Where the support member is not required, for example, when the open-cell foam has a hardness ensuring a self-standing configuration or when a self-standing member other than the open-cell foam is used as the mist trap, the support member can be omitted.

As mentioned hereinabove, the nozzle 7 is positioned above the mist trap 25 and the spraying angle thereof, distance from the nozzle to the mist trap 25, spraying pressure, and spray particle size are adjusted such as to allow the sprayed removal solution to pass evenly into the vacuum vessel 9. In the present embodiment, one nozzle 7 is used, but two or more nozzles can be also used according to the volume of the vacuum vessel 9 or the amount of the removal solution to be treated per unit time.

The gas introducing mechanism 13 is a leak valve. Where this leak valve is open in a state in which the vacuum pump 11 is driven and the interior of the vacuum vessel 9 is depressurized, the evaporation enhancing gas is sucked in and introduced into the vacuum vessel 9 (in FIG. 1 illustrating the present embodiment, the introduction of the atmospheric air is shown, but the heated compressed air from the compressor 19 may be directly introduced therein). Instead of providing the leak valve, it is also possible to introduce the evaporation enhancing gas into the vacuum vessel 9 via the nozzle 7. Further, the evaporation enhancing gas may be also introduced by both the leak valve and the nozzle 7. In these cases, the nozzle 7 can perform both the function of spraying the removal solution to be treated and the function of the gas introducing mechanism 13.

The operation of the regeneration and recovery apparatus of the embodiment will be explained below with reference to FIG. 1. With the regeneration and recovery apparatus 1, the removal solution stored inside the storage tank 3 is pumped by the liquid pump 5, the temperature of the removal solution is raised by heat exchange with the compressed air from the compressor 19 in the heat exchanger 21, and the removal solution is then sprayed from the nozzle 7 inside the vacuum vessel 9. Meanwhile, the compressed air that has been cooled, while maintaining a high pressure, by heat exchange with the removal solution in the heat exchanger 21 is stored in the air tank 23. The liquid pump 5 is an air-driven pump having compressed air as a drive source. The compressed air stored in the air tank 23 is used as a drive source for the liquid pump after the pressure of the compressed air has been reduced to an adequate value by a pressure-reducing valve 31.

The interior of the vacuum vessel 9 is depressurized when the vacuum vessel 11 is driven, and VOC is vacuum evaporated from the removal solution sprayed from the nozzle 7 under the reduced pressure. Since the removal solution is sprayed in a mist-like form, the surface area thereof increases greatly in comparison with that obtained in simple storage. Furthermore, since the temperature of the removal solution has been raised in the heat exchanger 21, the removal solution is even easier to evaporate.

The mist-like removal solution to be treated reaches the open-cell foam constituting the mist trap 25 and adheres to the cell walls thereof. The surface area of the removal solution that has adhered to the cell walls further increases. The surface area of the removal solution that has expanded multiple times becomes very large. In combination therewith, the introduction of the evaporation enhancing gas (air) via the gas introducing mechanism 13 increases the efficiency of vacuum evaporation. Thus, the removal solution is efficiently recovered (converted into the regenerated removal solution). The removal solution becomes the regenerated removal solution, while passing through (descending in) the open-cell foam, passes through the open-cell foam and the support body and drops down.

The regenerated removal solution that has dropped down is discharged to the outside of the vacuum vessel 9 through the liquid discharge mechanism 15 and stored in the liquid storage tank 17. The regenerated removal solution stored in the liquid storage tank 17 is discharged as appropriate from the liquid storage tank 17. When the regenerated removal solution is discharged from the liquid storage tank 17, the discharge valve 18 provided in the lower portion of the liquid storage tank 17 is opened, the compressed air stored in the air tank 23 is introduced via a pipe 33 into the liquid storage tank 17, and the pressure inside the liquid storage tank 17 is raised, thereby facilitating the discharge of the regenerated removal solution to the outside. A pressure reducing valve 35, a speed controller 37, and a compressed air introducing valve 39 are provided in the pipe 33. The pressure and amount of the compressed air introduced from the air tank 23 into the liquid storage tank 17 can be adjusted with the pressure reducing valve 35 and the speed controller 37, and when the introduction of the compressed air from the air tank 23 into the liquid storage tank 17 is not required, the introduction can be terminated by closing the compressed air introducing valve 39.

A liquid discharge valve 40 is provided in front of the liquid storage tank 17, and by using an air-operated switching control valve that uses the compressed air from the air tank 23, it is possible to store the removal solution discharged from the vacuum vessel 9 alternately in two liquid storage tanks 17.

The gas introducing mechanism 13 will be additionally explained below. First, the results relating to a toluene recovery ratio from a VOC removal solution obtained with the conventional technique will be explained. A PV method (pervaporation method) using membrane separation is known as the conventional method for regenerating a VOC removal solution including VOC. However, such method yields an extremely low (about 0.027%) toluene recovery ratio from the VOC liquid, and real-time regeneration of VOC removal solution is difficult.

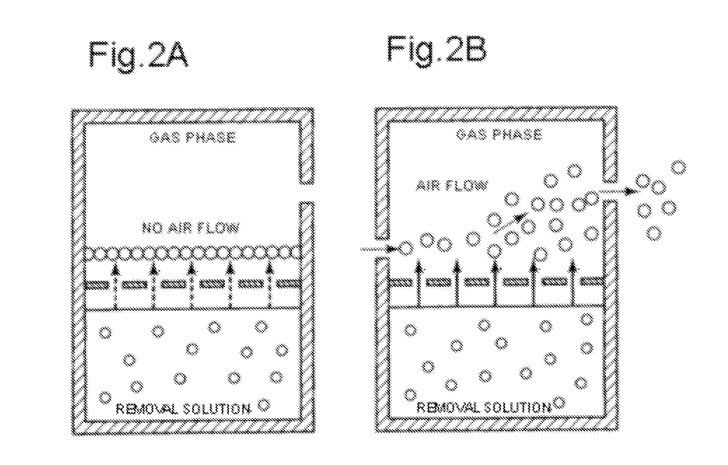

Accordingly, the amount of evaporated VOC can be increased by a vacuum evaporation method using a porous membrane in order to reduce the membrane permeation resistance, as shown in FIG. 2A. The evaporation concentration of toluene in the aforementioned PV method is stabilized at about 70 ppm and the recovery ratio is about 0.027%, whereas the toluene evaporation concentration obtained with the vacuum evaporation method using the porous membrane such as shown in FIG. 2A is stabilized at about 200 ppm and the recovery ratio is 0.077% and increased by a factor of three with respect to that obtained with the PV method. However, even with the vacuum evaporation method using the porous membrane such as shown in FIG. 2A, the real-time regeneration of VOC removal solution is difficult.

Thus, as described hereinabove, with the conventional method, the process is implemented under a high vacuum of not more than several tens of Pa, and therefore no air flow is involved and the evaporated VOC cannot be recovered with good efficiency. By contrast, with the air-flow vacuum evaporation method, as shown in FIG. 2B, the air is introduced into the vacuum vessel, the degree of vacuum therein is reduced and the evaporated VOC are recovered, while being surrounded by air flow. Such a method has been confirmed to enable efficient recovery of VOC at a comparatively low degree of vacuum of about several thousands of Pa in toluene evaporation. Further, with the air-flow vacuum evaporation method in accordance with the present invention in which the removal solution is sprayed without using a gas permeable membrane, the toluene evaporation concentration was stabilized at about 2900 ppm and the recovery ratio was 93.5%.

In other words, in accordance with the present invention, the VOC recovery ratio (93.5%) is greatly increased over that obtained by the conventional method and real-time regeneration for the removal solution is made possible.

Further, in accordance with the present invention, the thermal energy of the compressed air is used for heating the removal solution to be treated. As a result, the removal solution can be heated and vacuum evaporation can be performed more efficiently. Further, when the thermal energy of the high-temperature and high-pressure compressed air generated in the compressor is transferred to the removal solution by using the heat exchanger provided inside the vacuum vessel, the removal solution can be heated safely and efficiently, without heating the removal solution outside the vacuum container.

Further, since the pressure energy of the compressed air that has been cooled after the heat exchange is used as a power source of the liquid pump 5 for pumping the removal solution into the vacuum vessel and is also used as a pumping function for discharging the separated removal solution from the liquid storage tank with good efficiency, the energy of the compressed air generated by the compressor can be used effectively without loss.

Since the compressed air is used as the means for heating the removal solution to be treated, it is not necessary to use a heater for heating the removal solution, power required for the heater can be saved, the release of CO₂ can be reduced, and the danger of ignition caused by the heater can be avoided. In other words, since the apparatus uses the air, it is safe and does not require to have an explosion-proof structure.

Further, by using the pressure energy of the compressed air that has been cooled by heat exchange with the removal solution to be treated, the discharge of the regenerated removal solution after the separation using the air-driven pump and air pressure can be used effectively as a serial system and energy efficiency of the entire apparatus can be increased.

Thus, a VOC removal solution regeneration and recovery apparatus and a VOC removal solution regeneration and recovery method can be used in which no heater is required and therefore the release of CO₂ can be reduced by the amount corresponding to the power consumed when the heater is used and in which no gas-permeable membrane is required and therefore volatile compounds are not adversely affected when passing through the gas-permeable membrane.

What is claimed is:

1. A VOC removal solution regeneration and recovery apparatus that regenerates and recovers a VOC removal solution by removing VOC included in the VOC removal solution, the apparatus comprising:
a liquid pump and a nozzle that spray the VOC removal solution;
a vacuum vessel that has the nozzle disposed inside thereof;
a vacuum pump that depressurizes an interior of the vacuum vessel and vacuum-evaporates the VOC included in the VOC removal solution;
a gas introducing mechanism that introduces an evaporation enhancing gas into the vacuum vessel; and
a liquid discharge mechanism that discharges the processed VOC removal solution from the vacuum vessel,
the apparatus further comprising:
a compressor that compresses air supplied from the outside and generates compressed air having thermal energy and pressure energy, wherein
a heat exchanger is provided at a passage from the liquid pump to the nozzle, heat exchange between the VOC removal solution and the compressed air is performed by the heat exchanger, and the thermal energy is supplied to the VOC removal solution.

2. The VOC removal solution regeneration and recovery apparatus according to claim 1, wherein the liquid pump is an air-driven pump that is driven by air pressure as a power source, and the pressure energy of the compressed air is used as the power source of the liquid pump.

3. The VOC removal solution regeneration and recovery apparatus according to claim 1, comprising a liquid storage tank that stores the VOC removal solution discharged from the liquid discharge mechanism, wherein
compressed air introducing means is provided for introducing into the liquid storage tank the compressed air after the heat exchange by the heat exchanger.

4. The VOC removal solution regeneration and recovery apparatus according to claim 3, wherein two liquid storage tanks are provided to allow alternate storage of the removal solution.

5. The VOC removal solution regeneration and recovery apparatus according to claim 3, wherein an air tank is provided that stores the compressed air after the heat exchange by the heat exchanger.

6. The VOC removal solution regeneration and recovery apparatus according to claim 5, wherein compressed air from the compressor is used for the evaporation enhancing gas.

7. A VOC removal solution regeneration and recovery method for regenerating and recovering a VOC removal solution by removing VOC included in the VOC removal solution,
the method comprising: depressurizing an interior of a vacuum vessel with a vacuum pump, while spraying into the interior of the vacuum vessel the VOC removal solution that has been heated by heat exchange with a compressed gas generated by a compressor, and vacuum-evaporating VOC included in the VOC removal solution by introducing an evaporation enhancing gas into the vacuum vessel.

8. The VOC removal solution regeneration and recovery method according to claim 7, wherein the compressed air after the heat exchange is used as a power source of a liquid pump for spraying the VOC removal solution.

9. The VOC removal solution regeneration and recovery method according to claim 7, wherein
the VOC removal solution after the VOC have been vacuum-evaporated is stored in a liquid storage tank provided outside the vacuum vessel; and
the VOC removal solution is discharged from the liquid storage tank by the pressure of the compressed air after the heat exchange.
